(19) United States
(12) Patent Application Publication
(10) Pub. No.: US 2012/0085317 A1
(43) Pub. Date: Apr. 12, 2012

(54) Method for Reducing Engine Emissions Using a Liquid Aerosol Catalyst

(75) Inventors: George M. Malouf, Irvine, CA (US); Gary C. Lawson, Orem, UT (US); Brian Malm, Spring, TX (US)

(73) Assignee: EMISSIONS TECHNOLOGY, INC., Houston, TX (US)

(21) Appl. No.: 13/270,526

(22) Filed: Oct. 11, 2011

Related U.S. Application Data
(60) Provisional application No. 61/392,286, filed on Oct. 12, 2010.

(51) Int. Cl. F02M 43/00

(52) U.S. Cl. 123/304

(57) ABSTRACT

A catalyst composition and method of improving fuel efficiency and reduced emissions in combustion engines is disclosed. A liquid aerosol catalyst is introduced in to the air intake stream of a combustion engine and allowed to react during the oxidation of the fuel in the combustion chamber. The catalyst mixture contains platinum, rhenium, cerium, alcohol, and water.

### FIELD OF THE INVENTION

The present invention relates generally to a liquid catalyst in an aerosol form that is introduced into a combustion engine for the purpose of reducing the exhaust emissions and fuel consumption of the engine, while at the same time, reducing the carbon and soot ingestion into the lubricating oil of the engine. The catalyst improves fuel efficiency in combustion chambers by introducing the catalyst simultaneously into the combustion chamber of the engine with the incoming air stream. The catalyst mixture includes platinum, rhenium, and cerium compounds in an alcohol and water solution.

### BACKGROUND OF THE INVENTION

Catalysts are used in combustion reactions to increase the efficiency and energy outputs of all types of engines. In typical prior art catalyst combinations, the catalyst mixture includes platinum, rhodium, rhenium, and molybdenum. This mixture has been found to be corrosive and instable at high temperatures. Because the catalyst is introduced into the combustion chamber of the engine via an injector, the corrosive attribute of the catalyst is undesirable because the catalyst will cause the injector to corrode over time requiring new nozzles and the associated costs. Moreover, the combustion chamber of an engine operates at a high temperature over a long period of time. As the catalyst becomes more unstable due to this exposure to the high temperature, it is less efficient in carrying out the desired reactions.

The formulation of the catalyst of the current invention overcomes these challenges. In particular, it is less corrosive and stable at higher temperatures due to its unique formulation. In addition, it provides higher fuel efficiency and less emissions than the prior art catalysts. Also, it is a more cost effective formula than the prior art catalysts because it does not require rhodium which is an expensive material. Its unique formula allows it to function more efficiently than the prior art formulas that do contain rhodium

### SUMMARY OF THE INVENTION

The present invention is directed to a liquid aerosol catalyst that reduces the exhaust emissions and fuel consumption of a combustion engine. At the same time, the catalyst reduces carbon and soot ingestion into the lubricating oil of the engine.

The current invention includes a method for reducing engine emissions comprises the steps of providing a catalyst mixture, converting the catalyst mixture into an aerosol, and introducing the catalyst mixture into the combustion chamber of the engine via the incoming air stream. The catalyst mixture is metered into the combustion air stream in order to control the ratio of the catalyst metals to carbonaceous fuel at between 10-100 ppb.

The catalyst mixture is comprised of platinum, rhenium, and cerium compounds in a non-catalyst base of water and alcohol. The platinum serves as a catalyst to accelerate the combustion process between hydrocarbon and oxygen molecules. Platinum aids in lowering the minimum required temperature for hydrocarbon combustion and promotes the creation of free radical (reactive) oxygen which makes more usable oxygen available for the combustion process. Rhenium and cerium serve as co-catalysts with platinum to promote and accelerate the combustion process. A specific ratio must be maintained between the catalyst mixture and fuel to optimize the functionality of the reaction.

According to the present invention, the catalyst mixture contains 150-1600 milligrams platinum, 150-1600 milligrams cerium, 24-260 milligrams rhenium per liter of catalyst solution. The catalyst mixture further contains 10-60% alcohol with the balance water. Moreover, the catalyst mixture contains an alcohol selected from the following group: methanol, ethanol, propanol, butanol, ethylene glycol, propylene glycol, and polyethylene glycol.

It is an object of the present invention to provide a method to reduce exhaust emissions and fuel consumption in a combustion engine.

It is a further object of the present invention to provide a catalyst mixture that is non-corrosive.

It is a further object of the present invention to provide a catalyst mixture that is stable under high temperatures.

It is a further object of the present invention to provide a catalyst mixture that has a close to neutral pH to reduce corrosion.

It is a further object of the present invention to provide a catalyst mixture that is cost effective.

It is a further object of the present invention to provide a method wherein a catalyst mixture is introduced into a combustion chamber via the incoming air stream.

The novel features that are considered characteristic of the invention are set forth with particularity in the appended claims. The invention itself, however, both as to its structure and its operation together with the additional object and advantages thereof will best be understood from the following description of the preferred embodiment of the catalyst mixture. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase Likewise, the use of the words “function” or “means” in the Description of Preferred Embodiments is not intended to indicate a desire to invoke the special provision of 35 U.S.C. §112, paragraph 6 to define the invention. To the contrary, if the provisions o f 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### DESCRIPTION OF PREFERRED EMBODIMENTS

The present invention relates to increasing fuel efficiency and reducing emissions in a combustion engine. The catalyst works in a number of hydrocarbon combustion engines including, but not limited to internal combustion engines, boilers, furnaces, turbines, and any other open flame applications. More specifically, the intention of this invention is to provide a liquid catalyst in an aerosol form comprising a group of precious and non-precious metals in a substantially larger volume of non-catalyst base such as water and alcohol to improve fuel efficiency and reduce emissions.

A preferred composition of the catalyst for the purpose of reducing the exhaust emissions and fuel consumption, while at the same time reducing the carbon and soot ingestion into the lubricating oil of an engine, comprises a combination of platinum, rhenium, and cerium compounds in an alcohol and water solution. The combination of metal compounds and a carrier solution catalytically accelerates and more thoroughly completes the combustion reaction inside the combustion chamber for compression and spark ignition engines, thus reducing the amount of partially burned hydrocarbons that exit as soot in the exhaust stream as well as reducing the amount of unburned hydrocarbons, nitrogen oxides, carbon monoxide and carbon dioxide. Because the combustion is more complete, the engine generates more power per unit of fuel consumed so fuel consumption is reduced. Engine life is also extended due to reduced soot intrusion into the engine oil which causes engine wear. Additionally, fuel efficiency is increased and oil replacement and consumption are reduced creating a more cost effective combustion process.

In the preferred embodiment of the invention, the catalyst mixture is converted into an aerosol using a special air assisted injector nozzle. The injector nozzle introduces the aerosol into the combustion chamber of the engine simultaneously with the incoming air stream. Introduction of the catalyst as an aerosol into the air stream of the engine puts the catalyst in direct contact with the oxygen it will be reacting with to enhance the combustion process. The aerosol spray is rapidly vaporized and ready to react with the oxygen once it enters the combustion chamber. If the catalyst were mixed directly with the fuel, then it must find a way to come in contact with the air before it can split the air into free radical oxygen. The current invention is more effective than the prior art because the catalyst achieves very rapid contact through aerosol injection into the air stream of the engine as opposed to being mixed directly with the fuel. It is preferred that the catalyst is in the combustion chamber of the engine in vapor form or as a deposit on the non-wiped surfaces of the engine at the time of the combustion event. The non-wiped surface of the engine is the surface inside the combustion chamber that is not wiped off by action of the piston rings. Those surfaces are the cylinder head, walls at the top of the cylinder extending down to the first cylinder ring and the top surface of the cylinder including the valve caps.

As stated above, the preferred catalyst mixture includes platinum, rhenium, and cerium compounds in a carrier of alcohol and water. Unlike other prior catalyst combinations, the current mixture does not contain rhodium. Because of the high cost of rhodium, the current catalyst mixture is more cost effective than those in the prior art. In addition, the results shown in the combustion process using the mixture of the current invention provide evidence that the lack of rhodium does not have a negative effect. In fact, the combustion process is shown to be more complete.

In one experimental run, the catalyst was injected into a 1991 Detroit Diesel Corporation Series 60 (DDC60) engine. Compared to the baseline of the combustion process in the engine with no catalyst, fuel consumption was reduced by over 4%. Hydrocarbon emissions were reduced 25%, carbon monoxide was reduced 14%, and NO was reduced 6%. The first 7 hours of the test was the baseline run. During this time, the average fuel consumption rate was 2.58 g fuel/hp-min with a 3-sigma deviation of +/−0.8%. The catalyst was then injected into the engine for a 7.8 hour run. During this time, the fuel consumption dropped to 2.47 g/hp-min with a 3-sigma deviation of +/−1.6%. Next, the catalyst injection was turned off for 5.5 hours. After a short period of time, the fuel consumption began to increase toward the original baseline. Based on the slope of the return curve, it was estimated that the fuel consumption would return to the original baseline in 9-12 hours time. After the 5.5 hours, the catalyst injection was restarted. The recovery to the baseline (no catalyst) was terminated by the injection of the catalyst. Fuel consumption began to drop after of period of 4.2 hours at which time the test was stopped. Comparison of the baseline (no catalyst) against the first catalyst injection shows a 4.3% reduction in fuel consumption against the mean. Comparison of the upper and lower 3-sigma limits of the two runs showed a statistically valid reduction in fuel consumption of approximately 2% to 7%. Compared to the baseline, hydrocarbon emissions were reduced 14.6%, carbon monoxide was reduced 10%, and NOₓ was reduced 5.7%. The results of the catalyst in the experimental run can be seen in Table 1 below.

TABLE 1

| Time | | Fuel Consumption | THC | NOₓ | CO |
|---|---|---|---|---|---|
| (hours) | Catalyst | Rate (g fuel/hp-min) | (ppm) | (ppm) | (ppm) |
| 0-7 | None | 2.58 | 15.8 | 1007 | 230 |
| 7-14.8 | Metered | 2.47 | 13.5 | 950 | 207 |
| | Injection | | | | |
| 14.8-20.3 | None | Immediate increase | 12.9 | 1068 | 226 |
| | | toward 2.58 | | | |
| 20.3-24.5 | Metered | Began to decrease toward | 11.6 | 972 | 197 |
| | Injection | 2.47 after 4.2 hours | | | |

In the mixture, the platinum serves as a catalyst to accelerate the combustion process between hydrocarbon and oxygen molecules. In the preferred embodiment of the invention, the platinum in the catalyst mixture is present in the Pt⁺² valence state instead of the Pt⁺² valence state present in the prior art. The Pt⁺² valence state is more stable at higher temperatures and is less corrosive to metal surfaces. It has a more neutral pH value of 4.0 to 5.0 and is stable at temperatures above 165° F. This attribute is especially important in a catalyst that is injected through metal injectors into a combustion engine that operates at high temperatures. The metal injectors will not be as easily corroded by the catalyst mixture. In addition, the components of the catalyst mixture will not precipitate at the higher temperatures of the combustion engine.

In the preferred embodiment of the catalyst mixture, the catalyst mixture contains 150-1600 mg of platinum, 150-1600 mg of cerium, 24-260 mg of rhenium per liter of catalyst solution in 10-60% alcohol with the balance water. The most preferred embodiment of the catalyst mixture contains 700-900 mg of platinum, 80-150 mg of rhenium, and 800-1200 mg of cerium per liter of catalyst solution in 10-60% alcohol with the balance water. The alcohol in the catalyst mixture is selected from the group consisting of: methanol, ethanol, propanol, butanol, ethylene glycol, propylene glycol, polyethylene glycol, and any combination thereof. The most preferred alcohol is propylene glycol.

The catalyst mixture is metered into the combustion air stream through injector nozzles in order to control the ratio of the catalyst metals to the fuel. The preferred ratio of the catalyst metals to fuel is 10-100 parts per billion (ppb). The more preferred ratio is 60-80 ppb. The catalyst mixture is metered using a specialized injector that converts the liquid catalyst mixture into an aerosol. The catalyst injection system is designed to introduce the catalyst mixture as an aerosol into the air stream of the combustion engine at predetermined levels to assure catalyst is present in the combustion chambers at each combustion event.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for enhancing the oxidizing of a fuel in a combustion engine comprising the steps of:
providing a liquid catalyst mixture wherein the catalyst mixture comprises 700-900 milligram/liter platinum, 80-150 milligram/liter rhenium, 800-1200 milligram/liter cerium, 10-60% alcohol, and the balance water;
converting the liquid catalyst mixture into an aerosol through an injector;
injecting the catalyst mixture into an air intake stream of a combustion engine; and
oxidizing the fuel in the combustion chamber with the catalyst mixture such that exhaust emissions are reduced and fuel efficiency is increased.

2. The method of claim 1 further comprising the step of metering the catalyst mixture into the air intake stream such that the ratio of the catalyst to fuel is 10-100 parts per billion.

3. The method of claim 2 wherein the catalyst mixture is metered at a ratio of catalyst to fuel is 60-80 parts per billion.

4. The method of claim 1 wherein the fuel is diesel fuel.

5. The method of claim 1 wherein the alcohol is selected from the group consisting of:
methanol;
ethanol;
propanol;
butanol;
ethylene glycol;
propylene glycol;
polyethylene glycol; and
any combination thereof.

6. The method of claim 1 wherein the alcohol is propylene glycol.

7. The method of claim 1 wherein the liquid catalyst mixture has a pH of at least 4.0.

8. The method of claim 1 wherein the liquid catalyst is stable at a temperature values of at least 165° F.

9. The method of claim 1 wherein the platinum is in the Pt²⁺ valence state.
